(19) United States
(12) Patent Application Publication
(10) Pub. No.: US 2019/0236997 A1
(43) Pub. Date: Aug. 1, 2019

(54) DISPLAY DRIVING METHOD AND ORGANIC LIGHT-EMITTING DISPLAY DEVICE THEREOF

(71) Applicant: Shanghai Tianma AM-OLED Co., Ltd., Shanghai (CN)

(72) Inventor: Lijing HAN, Shanghai (CN)

(21) Appl. No.: 16/170,127

(22) Filed: Oct. 25, 2018

(30) Foreign Application Priority Data
Jan. 31, 2018 (CN) 201810098684.1

(51) Int. Cl. G09G 3/20; G09G 3/3208

(52) U.S. Cl. CPC G09G 3/2003; G09G 3/3208; G09G 2320/0233; G09G 2300/0452; G09G 2320/045; G09G 2320/0242

(57) ABSTRACT

Organic light-emitting display panel and driving method thereof, and organic light-emitting display device are provided. The organic light-emitting display panel includes a plurality of pixel groups, and a pixel group includes at least three sub-pixels, which are used to emit light of three different colors, respectively. A duration of the organic light-emitting display panel displaying one frame image includes a display period, which includes at least two light-emitting stages. In any one light-emitting stage, in any one pixel group, at least one sub-pixel emits light. The display driving method includes in one display period, adjusting a display color of the any one pixel group by adjusting a magnitude of a driving current of each sub-pixel and adjusting a light-emitting duration of the each sub-pixel. The driving current of the each sub-pixel in the any one pixel group is generated by an independent pixel driving circuit, and is substantially equal.

### CROSS-REFERENCES TO RELATED APPLICATIONS

This application claims the priority of Chinese patent application No. 201810098684.1, filed on Jan. 31, 2018, the entirety of which is incorporated herein by reference.

### FIELD OF THE DISCLOSURE

The present disclosure generally relates to the field of display technology and, more particularly, relates to a display driving method and an organic light-emitting display panel/device thereof.

### BACKGROUND

An organic light-emitting diode (OLED) display panel, i.e., an organic light-emitting display panel, is featured with advantages such as thin thickness, light weight, active illumination, bright picture, low power consumption, desired flexibility, and wide color gamut, etc., and has become new generation of display technology after thin film transistor-liquid crystal display (TFT-LCD) technology.

The OLED is driven by current, and the current is transmitted through metal wires in the display panel. Because the metal wire has a resistance, from a current input terminal to a terminal far from the current input terminal, a voltage will gradually decrease, i.e., IR-drop. The IR-drops of the OLED devices for emitting light of different colors are different. In other words, the IR-drops of sub-pixels of different colors are different. Therefore, due to the IR-drop, the sub-pixels disposed at the current input terminal and at the terminal far from the current input terminal and supposed to emit light of a same color will show different colors, resulting in a poor chromaticity uniformity of the organic light-emitting display panel.

Therefore, to solve the above issues, how to provide a display driving method and an organic light-emitting display device has become an urgent technical problem to be solved. The disclosed display driving method and organic light-emitting display device are directed to solve one or more problems set forth above and other problems.

### BRIEF SUMMARY OF THE DISCLOSURE

One aspect of the present disclosure provides a display driving method for driving an organic light-emitting display panel. The organic light-emitting display panel includes a plurality of pixel groups, a pixel group of the plurality of pixel groups includes at least three sub-pixels, and the at least three sub-pixels are used to emit light of three different colors, respectively. A duration of the organic light-emitting display panel displaying one frame image includes a display period, the display period includes at least two light-emitting stages. In any one of the light-emitting stages, in any one pixel group of the plurality of pixel groups, at least one sub-pixel emits light. The display driving method includes in one display period, adjusting a display color of the any one pixel group by adjusting a magnitude of a driving current of each sub-pixel in the any one pixel group and adjusting a light-emitting duration of the each sub-pixel. The driving current of the each sub-pixel is generated by an independent pixel driving circuit, and the driving current of the each sub-pixel in the any one pixel group is substantially equal.

Another aspect of the present disclosure provides an organic light-emitting display panel driven by a display driving method. The organic light-emitting display panel includes a plurality of pixel groups, each including at least three sub-pixels used to respectively emit light of three different colors. A duration of the organic light-emitting display panel displaying one frame image includes a display period, the display period includes at least two light-emitting stages, and in any one of the light-emitting stages, in any one pixel group of the plurality of pixel groups, at least one sub-pixel emits light. In one display period, a display color of the any one pixel group is adjusted by adjusting a magnitude of a driving current of each sub-pixel in the any one pixel group and adjusting a light-emitting duration of the each sub-pixel. The driving current of the each sub-pixel is generated by an independent pixel driving circuit, and the driving current of the each sub-pixel in the any one pixel group is substantially equal.

Other aspects of the present disclosure can be understood by those skilled in the art in light of the description, the claims, and the drawings of the present disclosure.

### BRIEF DESCRIPTION OF THE DRAWINGS

FIG. 1 illustrates a schematic diagram of an existing pixel driving principle;

FIG. 2 illustrates a schematic top view of an existing organic light-emitting display panel;

FIG. 3 illustrates a schematic top view of an exemplary organic light-emitting display panel consistent with disclosed embodiments of the present disclosure;

FIG. 4 illustrates a schematic top view of another exemplary organic light-emitting display panel consistent with disclosed embodiments of the present disclosure;

FIG. 5 illustrates a schematic top view of another exemplary organic light-emitting display panel consistent with disclosed embodiments of the present disclosure;

FIG. 6 illustrates a schematic top view of another exemplary organic light-emitting display panel consistent with disclosed embodiments of the present disclosure;

FIG. 7 illustrates a schematic diagram of an exemplary pixel group consistent with disclosed embodiments of the present disclosure;

FIG. 8 illustrates a timing sequence diagram of an exemplary display driving method consistent with disclosed embodiments of the present disclosure;

FIG. 9 illustrates another timing sequence diagram of an exemplary display driving method consistent with disclosed embodiments of the present disclosure;

FIG. 10 illustrates another timing sequence diagram of an exemplary display driving method consistent with disclosed embodiments of the present disclosure;

FIG. 11 illustrates another timing sequence diagram of an exemplary display driving method consistent with disclosed embodiments of the present disclosure;

FIG. 12 illustrates another timing sequence diagram of an exemplary display driving method consistent with disclosed embodiments of the present disclosure;

FIG. 13 illustrates another timing sequence diagram of an exemplary display driving method consistent with disclosed embodiments of the present disclosure;

FIG. 14 illustrates another timing sequence diagram of an exemplary display driving method consistent with disclosed embodiments of the present disclosure;

FIG. 15 illustrates another timing sequence diagram of an exemplary display driving method consistent with disclosed embodiments of the present disclosure;

FIG. 16 illustrates another timing sequence diagram of an exemplary display driving method consistent with disclosed embodiments of the present disclosure; and

FIG. 17 illustrates a schematic top view of an exemplary organic light-emitting display device consistent with disclosed embodiments of the present disclosure.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

Similar reference numbers and letters represent similar terms in the following Figures, such that once an item is defined in one Figure, it does not need to be further discussed in subsequent Figures.

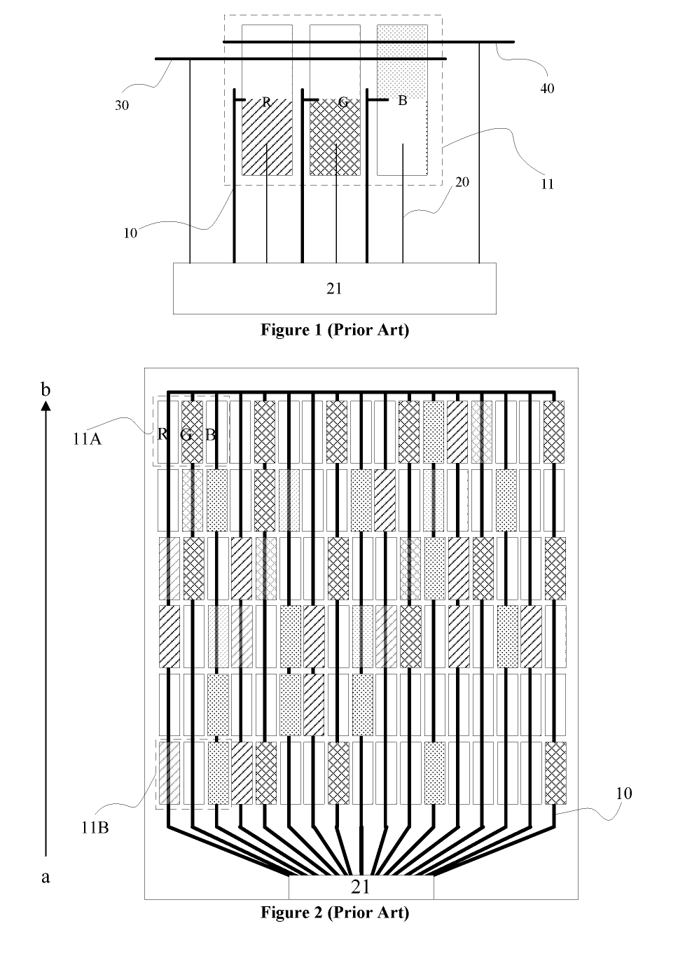

FIG. 1 illustrates a schematic diagram of an existing pixel driving principle. Referring to FIG. 1, a pixel 11 includes three sub-pixels, which are sub-pixels R, G, and B, respectively. When the pixel is used for display, a driving chip 21 supplies a power voltage for a power line 10, a data signal for a data line 20, a light-emitting signal for a light-emitting signal line 30 (i.e., an Emit signal line), and a gate signal for a gate line 40. In a driving process, the sub-pixels R, G, and B receive the gate signal, perform initialization and voltage reset, then receive the data signals and hold the data signals. After the sub-pixels R, G, and B receive the light-emitting signal, the power voltage signals are transmitted to the sub-pixels R, G, and B through the power lines 10, respectively. A driving current of each of the sub-pixels R, G, and B is affected by the power voltage on the power line 10 and the data signal written by the data line 20. The power voltage on the power line is often controlled by the data signal. In other words, by controlling a magnitude of the data signal of a certain sub-pixel, a magnitude of the power voltage on the power line 10 of the certain sub-pixel can be controlled, and a magnitude of the driving current of the certain sub-pixel can be controlled.

FIG. 2 illustrates a schematic top view of an existing organic light-emitting display panel. Referring to FIG. 2, a driving voltage is provided to the organic light-emitting display panel through the driving chip 21. In a direction from ‘a’ to ‘b’, i.e., a direction from a terminal close to the driving chip 21 to a terminal away from the driving chip 21, because the power line 10 has a resistance, the power line 10 has the IR-drop. Therefore, with respect to the ‘a’ terminal, the power line 10 has a smaller voltage at the ‘b’ terminal. The macroscopic performance of the IR-drop is a decrease in the luminance of the light.

In a display process of the display panel, a light-emitting ratio of each sub-pixel in a same one pixel is different. In other words, the driving current of each sub-pixel in a same one pixel is different. Therefore, when the power line 10 has a uniform resistance, the IR-drop on the power lines 10 that supply the driving current for each sub-pixel in a same one pixel is different, which causes allocated driving current of each sub-pixel in the same one pixel to change. Thus, a display color of the one pixel is different from a target color, which affects the chromaticity uniformity of the display panel. For example, when a pixel 11A has a same target color as a pixel 11B, the light-emitting ratio of each sub-pixel in the pixel 11A is different from the light-emitting ratio of each sub-pixel in the pixel 11B due to the influence of the IR-drop. Therefore, after mixing the colors, the pixel 11A displays a color different from the pixel 11B. Although reduction of the resistance of the power line 10 facilitates to improve the chromaticity uniformity of the organic light-emitting display panel, the power line 10 still has a resistance of a certain value due to limitations of processes, materials, and applications. Therefore, the IR-drop is still one of key factors that affect the chromaticity uniformity of the organic light-emitting display panel. Because the writing of the data signal is completed instantaneously, the IR-drop on the signal line has little influence on the driving current of the sub-pixel.

To solve the above technical issues, the present disclosure provides a display driving method and an organic light-emitting display device, which may improve the chromaticity uniformity of the organic light-emitting display device and further improve the display performance of the display device. The display driving method and the organic light-emitting display device in the disclosed embodiments will be described in detail below with reference to the accompanying drawings.

The display driving method in the disclosed embodiments may be used to drive an organic light-emitting display panel. FIG. 3 illustrates a schematic top view of an organic light-emitting display panel consistent with disclosed embodiments of the present disclosure. Referring to FIG. 3, the organic light-emitting display panel may include a plurality of pixel groups 11. A pixel group may include at least three sub-pixels 111, and the three sub-pixels 111 may be used to emit light of three different colors, respectively. The pixel group 11 may be formed by three sub-pixels in one pixel unit in the display panel as shown in FIG. 3.

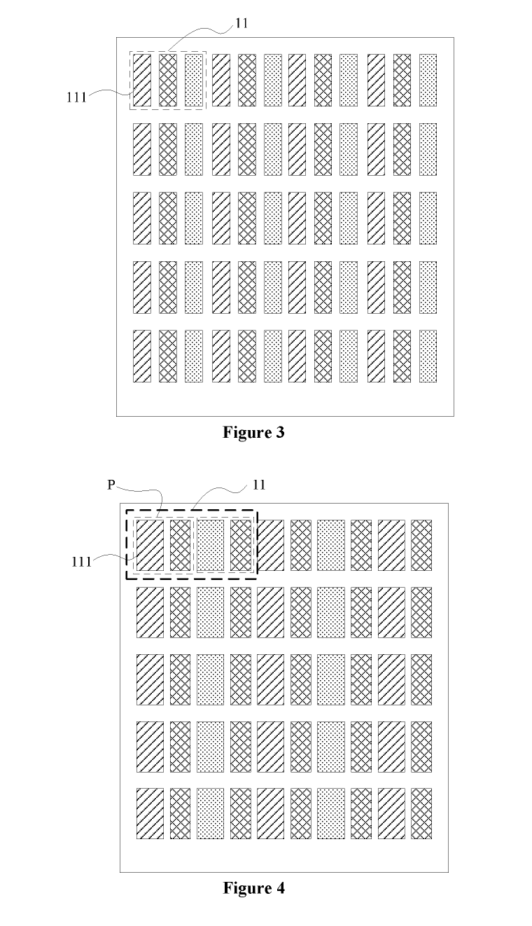

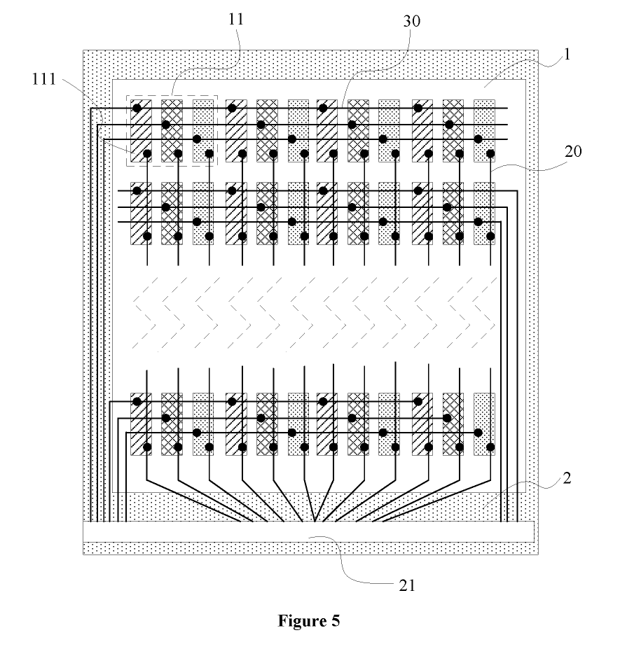

FIG. 4 illustrates a schematic top view of another organic light-emitting display panel consistent with disclosed embodiments of the present disclosure. Referring to FIG. 4, the pixel group 11 in the disclosed embodiments may be formed by two adjacent pixel units P, and the two adjacent pixel units P may have sub-pixels 111 of three different colors. For illustrative purposes, the arrangement structures of the sub-pixels in FIGS. 3 and 4 are used as examples, and the display panel may also adopt other arrangement structures of the sub-pixels.

During display, a duration of the organic light-emitting display panel displaying one frame image may include a display period. The display period may include at least two light-emitting stages. In any one of the light-emitting stages, at least one sub-pixel 111 in any one pixel group 11 may emit light. In one display period, the driving current of the each sub-pixel 111 in any one pixel group 11 may be substantially equal. The driving current of the each sub-pixel 111 may be generated by an independent pixel driving circuit. The display color of the pixel group may be adjusted by adjusting the magnitude of the driving current and adjusting the light-emitting duration of each sub-pixel 111. For a sub-pixel 111, a total light-emitting amount thereof may be proportional to a square of the driving current for driving the sub-pixel 111 in one display period. In one embodiment, the total light-emitting amount of the sub-pixel in one display period is Q, the light-emitting duration is to, and the driving current is i, then Q=ki²t₀ (k is a proportional coefficient). Therefore, the total light-emitting amount of the sub-pixel 111 may be adjusted by adjusting the driving current and the light-emitting duration. For a pixel group 11, the ratio of the total light-emitting amount of each sub-pixel 111 in one display period may determine the display color of the pixel group.

In one embodiment, the display color may be adjusted by adjusting the magnitude of the driving current and adjusting the light-emitting duration of the each sub-pixel. Therefore, ensuring the driving current of the each sub-pixel in a same pixel group to be substantially equal, and ensuring the IR-drops on the power lines of the sub-pixels of different colors to be substantially equal, may enable the light-emitting allocation of each sub-pixel in the pixel group to be substantially close to the target color, thereby improving the chromaticity uniformity of the organic light-emitting display panel, and improving the display performance. Moreover, in an organic light-emitting display panel driven by an existing driving method, an organic light-emitting device that emits blue light desires a substantially large driving current, which lowers the lifetime of a blue sub-pixel, and, thus, a lifetime of the blue sub-pixel is often short. In the display driving method in the disclosed embodiments, the driving current of the each sub-pixel may be substantially equal, such that the lifetimes of sub-pixels of different colors may be substantially equal, which may facilitate to improve the service life of the organic light-emitting display panel.

Referring to FIGS. 3 and 4, if one sub-pixel 111 in one pixel group 11 emits light while the other sub-pixels do not emit light, the one pixel group may not have the color mixing of the light emitted from the sub-pixel 111, and the IR-drop may have almost no influence on the chromaticity uniformity of pure red screen, pure blue screen, and pure green screen. Therefore, the display driving method in the disclosed embodiments may be used to drive the organic light-emitting display panel to display a non-pure red screen, a non-pure blue screen, or a non-pure green screen. When displaying the non-pure red screen, the non-pure blue screen, or the non-pure green screen, because at least two sub-pixels 111 in one pixel group 11 emit light, the driving currents of the sub-pixels 111 that emit light may be controlled to be equal, thereby ensuring the IR-drop to have a same influence on the driving currents of sub-pixels 111 of different colors. Therefore, the chromaticity uniformity of the display panel may be improved, and the display performance may be improved. When displaying a pure white screen using an existing display driving method, the IR-drop has an obvious influence on the chromaticity uniformity, one side of the organic light-emitting display panel close to the driving chip is bright, and the other side thereof away from the driving chip is dark, and, thus, the display performance is poor. Therefore, for the display of the pure white screen, the driving method in the disclosed embodiments may significantly improve the chromaticity uniformity.

FIG. 5 illustrates a schematic top view of another organic light-emitting display panel consistent with disclosed embodiments of the present disclosure. Referring to FIG. 5, the display driving method in the disclosed embodiments may be used to drive the organic light-emitting display panel. The organic light-emitting display panel may include a display region 1 and a non-display region 2 surrounding the display region 1. A driving chip 21 may be disposed in the non-display region 2, and the driving chip 21 may provide a driving voltage for the organic light-emitting display panel to form a driving current. Sub-pixels 111 of a same color in a same one pixel row may be connected to a same one light-emitting signal line 30, and the light-emitting signal line 30 may be electrically connected to the driving chip 21. The driving chip 21 may respectively provide light-emitting signals for the sub-pixels 111 of different colors in the same one pixel row to control whether the sub-pixel 111 emits light or not. The method may control the light-emitting duration of each sub-pixel 111 by controlling the light-emitting signal of each sub-pixel 111 in the pixel group 11, respectively, thereby achieving the purpose of time-division driving of the sub-pixels. Data signal may be written through a writing data line 20 to control a voltage of a power line (not illustrated in FIG. 5), and to control the driving current of every sub-pixel 111 to be substantially equal.

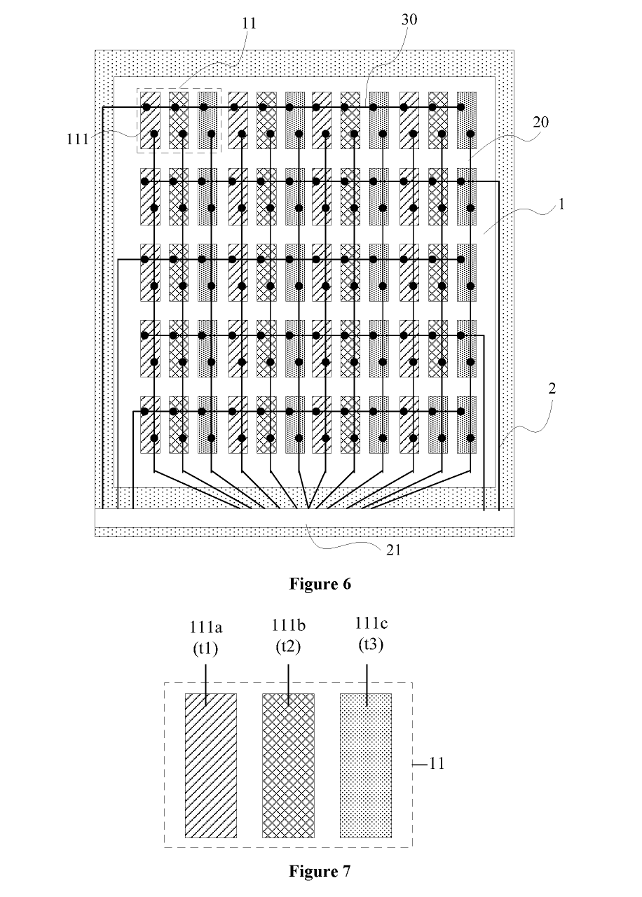

FIG. 6 illustrates a schematic top view of an organic light-emitting display panel consistent with disclosed embodiments of the present disclosure. Referring to FIG. 6, the organic light-emitting display panel may include a display region 1 and a non-display region 2 surrounding the display region 1. A driving chip 21 may be disposed in the non-display region 2, and the driving chip 21 may provide a driving voltage for the organic light-emitting display panel to form a driving current. Entire sub-pixels 111 in a same one pixel row may be connected to a same one light-emitting signal line 30. When a certain color changes from display to non-display (or from non-display to display), that is, when a light-emitting status of a sub-pixel 111 that emits light of a certain color in the pixel group changes, the time-division driving for each sub-pixel 111 may be realized by rewriting data signal on the data line 20. When the data signal written by the data line 20 controls a sub-pixel 111 to emit 0 nit light of brightness, the sub-pixel 111 may not emit light.

FIG. 7 illustrates a schematic diagram of a pixel group consistent with disclosed embodiments of the present disclosure. Referring to FIG. 7, in the display driving method in the disclosed embodiments, in one display period, three sub-pixels 111 in at least one pixel group 11 may emit light. The three sub-pixels 111 may be a first sub-pixel 111a, a second sub-pixel 111b, and a third sub-pixel 111c, respectively. A light-emitting duration of the first sub-pixel 111a may be a first duration t1, a light-emitting duration of the second sub-pixel 111b may be a second duration t2, and a light-emitting duration of the third sub-pixel 111c may be a third duration t3. A ratio of the first duration t1, the second duration t2, and the third duration t3 may be determined according to the display color of the pixel group 11. In one display period, in any one pixel group 11, a quantity of the sub-pixels 111 that emit light in every light-emitting stage may not be equal. The ratio of the first duration t1, the second duration t2, and the third duration t3 may be different, and, thus, different driving modes may be adopted. According to different ratios of the first duration t1, the second duration t2, and the third duration t3, different driving modes will be described as follows.

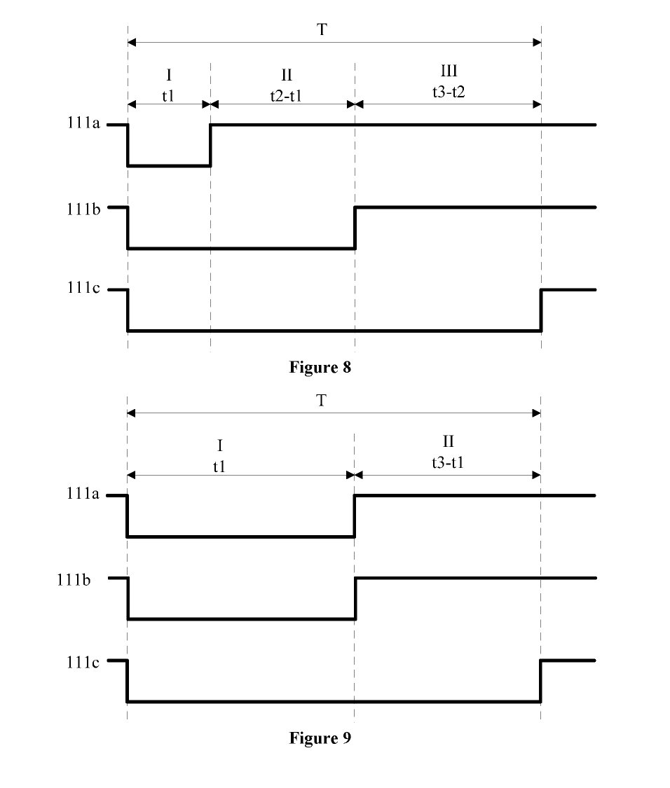

FIG. 8 illustrates a timing sequence diagram of the display driving method consistent with disclosed embodiments of the present disclosure. Referring to FIG. 8, in one embodiment, the first duration t1 may be less than the second duration t2, and the second duration t2 may be less than the third duration t3. The display period T may include three light-emitting stages: a first light-emitting stage I, a second light-emitting stage II, and a third light-emitting stage III, respectively. In the first light-emitting stage I, the first sub-pixel 111a, the second sub-pixel 111b, and the third sub-pixel 111c may emit light, and a duration of the first light-emitting stage I may be the first duration t1. In the second light-emitting stage II, the second sub-pixel 111b and the third sub-pixel 111c may emit light, and a duration of the second light-emitting stage II may be a difference between the second duration t2 and the first duration t1, i.e., t2−t1. In the third light-emitting stage III, the third sub-pixel 111c may emit light, and a duration of the third light-emitting stage III may be a difference between the third duration t3 and the second duration t2, i.e., t3−t2. In view of this, a duration of the display period T may be t3.

In one embodiment, because the driving current of each sub-pixel is substantially equal, the current on the power line in the each light-emitting stage may be substantially equal, which may facilitate to reduce the influence of the IR-drop of the power line on the chromaticity uniformity and improve the chromaticity uniformity of the display panel. Moreover, in a case where the resistance of the power line is uniform, when the driving current is small, the IR-drop of the power line, which is equal to the current multiplied by the resistance, may be substantially small, and the chromaticity difference between the side of the display panel close to the driving chip and the other side of the display panel away from the driving chip may be substantially small. Because the duration of the display panel displaying one frame image is fixed, the duration of the display period cannot be greater than the duration of the display panel displaying one frame image. In a case where the duration of the display period is fixed, the driving method in the disclosed embodiments may enable every sub-pixel to have a substantially long light-emitting duration, which may facilitate the reduction of the driving current and may further improve the chromaticity uniformity of the display panel.

FIG. 9 illustrates another timing sequence diagram of the display driving method consistent with disclosed embodiments of the present disclosure. Referring to FIG. 9, in one embodiment, the first duration t1 may be equal to the second duration t2, and the first duration t1 may be less than the third duration t3. The display period T may include two light-emitting stages: a first light-emitting stage I, and a second light-emitting stage II, respectively. In the first light-emitting stage I, the first sub-pixel 111a, the second sub-pixel 111b, and the third sub-pixel 111c may emit light, and a duration of the first light-emitting stage I may be the first duration t1. In the second light-emitting stage II, the third sub-pixel 111c may emit light, and a duration of the second light-emitting stage II may be a difference between the third duration t3 and the first duration t1, i.e., t3−t1. In view of this, a duration of the display period T may be t3.

In one embodiment, because the driving current of each sub-pixel is substantially equal, the current on the power line in the each light-emitting stage may be substantially equal, which may facilitate to reduce the influence of the IR-drop of the power line on the chromaticity uniformity and improve the chromaticity uniformity of the display panel. Moreover, in a case where the duration of the display period is fixed, the driving method in the disclosed embodiments may enable every sub-pixel to have a substantially long light-emitting duration, which may facilitate the reduction of the driving current and may further improve the chromaticity uniformity of the display panel. Further, when the light-emitting durations of two of the sub-pixels are substantially equal, the data signal may be written twice, which may facilitate to reduce the calculation amount of the driving chip.

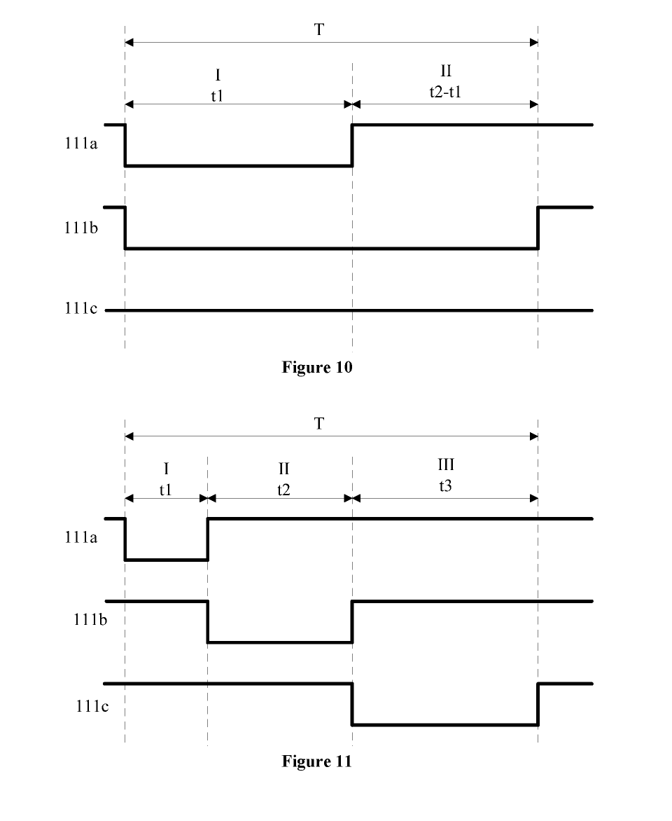

FIG. 10 illustrates another timing sequence diagram of the display driving method consistent with disclosed embodiments of the present disclosure. Referring to FIG. 10, in one embodiment, the third duration t3 may be equal to 0, and the first duration t1 may be less than the second duration t2. The display period T may include two light-emitting stages: a first light-emitting stage I, and a second light-emitting stage II, respectively. In the first light-emitting stage I, the first sub-pixel 111a and the second sub-pixel 111b may emit light, and a duration of the first light-emitting stage I may be the first duration t1. In the second light-emitting stage II, the second sub-pixel 111b may emit light, and a duration of the second light-emitting stage II may be a difference between the second duration t2 and the first duration t1, i.e., t2−t1. In view of this, a duration of the display period T may be t2.

In one embodiment, because the driving current of each sub-pixel is substantially equal, the current on the power line in the each light-emitting stage may be substantially equal, which may facilitate to reduce the influence of the IR-drop of the power line on the chromaticity uniformity and improve the chromaticity uniformity of the display panel. Moreover, in a case where the duration of the display period is fixed, the driving method in the disclosed embodiments may enable every sub-pixel to have a substantially long light-emitting duration, which may facilitate the reduction of the driving current and may further improve the chromaticity uniformity of the display panel.

Referring to FIGS. 8-10, in the driving method in which ratio of the light-emitting duration of each sub-pixel is different, the driving current of each sub-pixel in a same one pixel group may be ensured to be substantially equal, and the display color may be adjusted by adjusting the light-emitting duration of each sub-pixel. Because quantities of sub-pixels that emit light in each light-emitting stage is different, for one pixel group, the total driving current in the each light-emitting stage may be different. Therefore, the current on the power line electrically connected to the each sub-pixel in a same one pixel group in each light-emitting stage may not be exactly the same, while may have a substantially small difference, which may be far less than the difference in currents on the power lines in the prior art. Therefore, the influence of the IR-drops on the driving currents of the sub-pixels of different colors may be ensured to be substantially equal, the chromaticity uniformity of the display panel may be improved, and the display performance may be improved.

Referring to FIG. 7, in one embodiment, in the display driving method in the disclosed embodiments, in one display period, three sub-pixels 111 in at least one pixel group 11 may emit light. The three sub-pixels 111 may be the first sub-pixel 111a, the second sub-pixel 111b, and the third sub-pixel 111c, respectively. The light-emitting duration of the first sub-pixel 111a may be the first duration t1, the light-emitting duration of the second sub-pixel 111b may be the second duration t2, and the light-emitting duration of the third sub-pixel 111c may be the third duration t3. The ratio of the first duration t1, the second duration t2, and the third duration t3 may be determined according to the display color of the pixel group 11. In one display period, in any one pixel group 11, a quantity of the sub-pixels 111 that emit light in each light-emitting stage may be substantially equal. The ratio of the first duration t1, the second duration t2, and the third duration t3 may be different, and, thus, different driving modes may be adopted. According to different ratios of the first duration t1, the second duration t2, and the third duration t3, different driving modes will be described as follows.

FIG. 11 illustrates another timing sequence diagram of the display driving method consistent with disclosed embodiments of the present disclosure. Referring to FIG. 11, in one embodiment, the display period T may include three light-emitting stages: a first light-emitting stage I, a second light-emitting stage II, and a third light-emitting stage III, respectively. In the first light-emitting stage I, the first sub-pixel 111a may emit light, and a duration of the first light-emitting stage I may be the first duration t1. In the second light-emitting stage II, the second sub-pixel 111b may emit light, and a duration of the second light-emitting stage II may be the second duration t2. In the third light-emitting stage III, the third sub-pixel 111c may emit light, and a duration of the third light-emitting stage III may be the third duration t3. In view of this, a duration of the display period T may be a sum of the first duration t1, the second duration t2, and the third duration t3, i.e., t1+t2+t3.

In the driving method in the disclosed embodiments, the driving current of each sub-pixel in the pixel group may be substantially equal, which may improve the chromaticity uniformity of the organic light-emitting display panel. Moreover, in the prior art, to emit light of substantially equal brightness, the blue sub-pixel desires a substantially large driving current, and, thus, the service life of the blue sub-pixel is reduced. In the driving method in the disclosed embodiments, the driving current of the each sub-pixel in the pixel group may be substantially equal, which may facilitate to ensure the lifetime of the each sub-pixel to be substantially equal and to improve the lifetime of the display panel. Further, because one sub-pixel emits light in every light-emitting stage, not only the driving current of the each sub-pixel may be substantially equal, but also the current on the power line in the each light-emitting stage may be substantially equal. Therefore, the IR-drop on the power line may be substantially equal, and may have the same influence on illumination of each sub-pixel. Therefore, the IR-drop may not change the light-emitting ratio of each sub-pixel in the pixel group, such that the color of the light emitted from the pixel group may be close to the target color, which may maximize the chromaticity uniformity of the display panel and improve the display performance of the display panel.

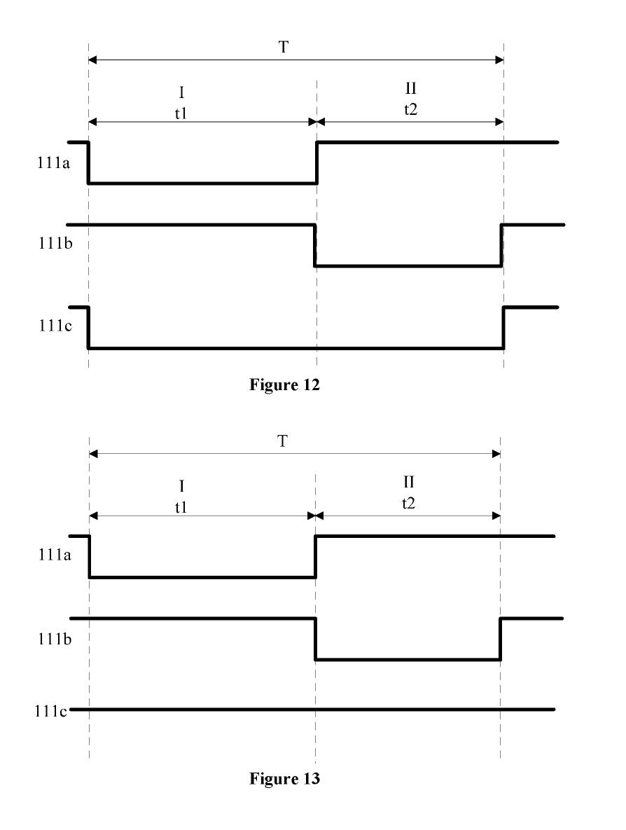

FIG. 12 illustrates another timing sequence diagram of the display driving method consistent with disclosed embodiments of the present disclosure. Referring to FIG. 12, in one embodiment, a sum of the first duration t1 and the second duration t2 may be equal to the third duration t3. The display period T may include two light-emitting stages: a first light-emitting stage I, and a second light-emitting stage II, respectively. In the first light-emitting stage I, the first sub-pixel 111a and the third sub-pixel 111c may emit light, and a duration of the first light-emitting stage I may be the first duration t1. In the second light-emitting stage II, the second sub-pixel 111b and the third sub-pixel 111c may emit light, and a duration of the second light-emitting stage II may be the second duration t2. In view of this, a duration of the display period T may be the third duration t3.

In the driving method in the disclosed embodiments, the driving current of each sub-pixel in the pixel group may be substantially equal, which may improve the chromaticity uniformity of the organic light-emitting display panel. Moreover, in the prior art, to emit light of substantially equal brightness, the blue sub-pixel desires a substantially large driving current, and, thus, the lifetime of the blue sub-pixel is reduced. In the driving method in the disclosed embodiments, the driving current of each sub-pixel in the pixel group may be substantially equal, which may facilitate to ensure the lifetime of each sub-pixel to be substantially equal and to improve the lifetime of the display panel. In addition, because a quantity of sub-pixels that emit light in every light-emitting stage is two, not only the driving current of the each sub-pixel may be substantially equal, but also the current on the power line in the each light-emitting stage may be substantially equal. Therefore, the IR-drop on the power line may be substantially equal, and may have the same influence on illumination of each sub-pixel. Therefore, the IR-drop may not change the light-emitting ratio of each sub-pixel in the pixel group, such that the color of the light emitted from the pixel group may be close to the target color, which may maximize the chromaticity uniformity of the display panel and improve the display performance of the display panel. Further, in the driving method in the disclosed embodiments, the data signal may be written twice, which may facilitate to reduce the calculation amount of the driving chip.

FIG. 13 illustrates another timing sequence diagram of the display driving method consistent with disclosed embodiments of the present disclosure. Referring to FIG. 13, in one embodiment, the third duration t3 may be equal to 0. The display period T may include two light-emitting stages: a first light-emitting stage I, and a second light-emitting stage II, respectively. In the first light-emitting stage I, the first sub-pixel 111a may emit light, and a duration of the first light-emitting stage I may be the first duration t1. In the second light-emitting stage II, the second sub-pixel 111b may emit light, and a duration of the second light-emitting stage II may be the second duration t2. In view of this, a duration of the display period T may be a sum of the first duration t1 and the second duration t2, i.e., t1+t2.

In the driving method in the disclosed embodiments, the driving current of each sub-pixel in the pixel group may be substantially equal, which may improve the chromaticity uniformity of the organic light-emitting display panel. Moreover, in the prior art, to emit light of substantially equal brightness, the blue sub-pixel desires a substantially large driving current, and, thus, the lifetime of the blue sub-pixel is reduced. In the driving method in the disclosed embodiments, the driving current of each sub-pixel in the pixel group may be substantially equal, which may facilitate to ensure the lifetime of each sub-pixel to be substantially equal and to improve the lifetime of the display panel. In addition, because one sub-pixel emits light in every light-emitting stage, not only the driving current of the each sub-pixel may be substantially equal, but also the current on the power line in the each light-emitting stage may be substantially equal. Therefore, the IR-drop on the power line may be substantially equal, and may have the same influence on illumination of each sub-pixel. Therefore, the color of the light emitted from the pixel group may be close to the target color, the chromaticity uniformity of the display panel may be improved, and the display performance may be improved. Further, the driving method in the disclosed embodiments may be applicable to a case where two sub-pixels in the pixel group may emit light.

Referring to FIGS. 11-13, in the driving method in which ratio of the light-emitting duration of each sub-pixel is different, the display color of the pixel group may be adjusted by adjusting the light-emitting duration of each sub-pixel in the pixel group. Because the driving current of each sub-pixel in a same one pixel group is substantially equal and a quantity of sub-pixels that emit light in each light-emitting stage is substantially equal, the driving current on the power line in the each light-emitting stage may be substantially equal.

Therefore, the IR-drop on the power line may be substantially equal, and may have the same influence on the illumination of the each sub-pixel. Thus, the color of the light emitted from the pixel group may be close to the target color, the chromaticity uniformity of the display panel may be improved, and the display performance may be improved.

In the driving method in the disclosed embodiments, the light-emitting duration of each light-emitting stage may be substantially equal, and the display panel may be driven by adjusting the quantity of the light-emitting stages to adjust the light-emitting duration of each sub-pixel. In other words, in one display period, the duration of the each light-emitting stage may be substantially equal, and the quantity of the light-emitting stages may be adjusted to adjust the light-emitting duration of each sub-pixel. Further, the duration of the light-emitting stage may be equal to a greatest common divisor of the light-emitting durations of each sub-pixel. For example, in one display period T, the total amount of illumination of the first sub-pixel 111a, the second sub-pixel 111b, and the third sub-pixel 111c in a certain pixel group may be approximately 2:3:6. Because the driving current of each sub-pixel is equal, the ratio of the light-emitting duration of each sub-pixel may be approximately 2:3:6. The quantity of total light-emitting stages may be 11, the duration of each light-emitting stage is t, and then the quantity of the light-emitting stages of each sub-pixel may be 2, 3, and 6, respectively. The driving method in the disclosed embodiments will be described in detail in conjunction with such specific example.

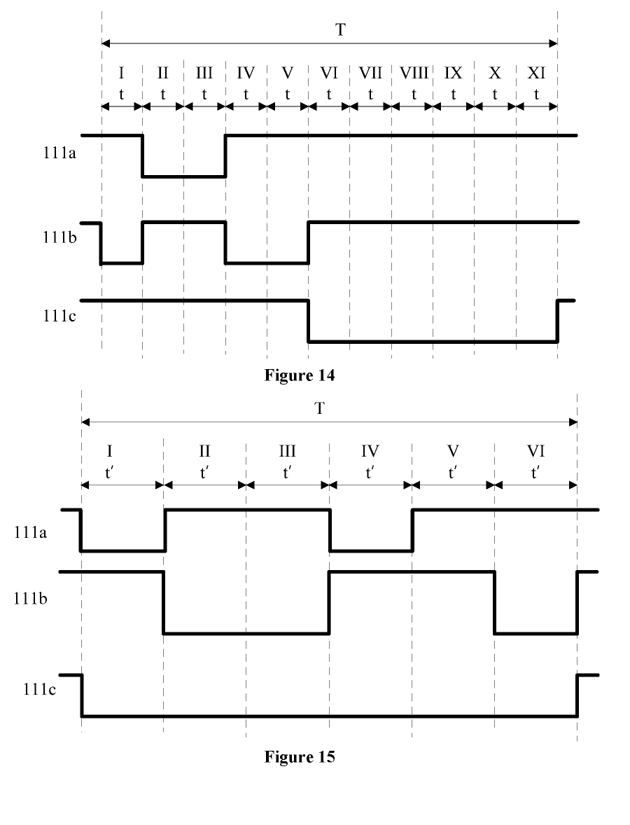

FIG. 14 illustrates another timing sequence diagram of the display driving method consistent with disclosed embodiments of the present disclosure. Referring to FIG. 14, in the display driving method in the disclosed embodiments, in one display period, the duration of the each light-emitting stage may be substantially equal, and each is t. The quantity of sub-pixels that emit light in each light-emitting stage may be substantially equal. In the first light-emitting stage I, the second sub-pixel 111b may emit light. In the second light-emitting stage II and the third light-emitting stage III, the first sub-pixel 111a may emit light. In the fourth light-emitting stage IV and the fifth light-emitting stage V, the second sub-pixel 111b may emit light. In the remaining six light-emitting stages VI-XI, the third sub-pixel 111c may emit light. In view of this, the duration of the display period T may be 11t.

Two or more light-emitting stages of one sub-pixel may or may not be adjacent, which may not affect the implementation of the driving method in the disclosed embodiments. The duration of each light-emitting stage may be substantially equal, and the light-emitting duration of each sub-pixel may be adjusted by adjusting the quantities of light-emitting stages of each sub-pixel. The driving current of each sub-pixel may be substantially equal, and the quantities of sub-pixels that emit light in each light-emitting stage may be substantially equal. Therefore, the IR-drop may have the same influence on the each sub-pixel, the influence of the IR-drops on the power lines on the chromaticity uniformity of the display panel may be improved, and the display performance may be improved.

FIG. 15 illustrates another timing sequence diagram of the display driving method consistent with disclosed embodiments of the present disclosure. Referring to FIG. 15, in the display driving method in the disclosed embodiments, in one display period, the duration of each light-emitting stage may be substantially equal, and each is t′. The quantity of sub-pixels that emit light in each light-emitting stage may be different. In the first light-emitting stage I, the first sub-pixel 111a, the second sub-pixel 111b, and the third sub-pixel 111c may emit light. In the second light-emitting stage II and the third light-emitting stage III, the second sub-pixel 111b and the third sub-pixel 111c may emit light. In the fourth light-emitting stage IV, the first sub-pixel 111a and the third sub-pixel 111c may emit light. In the fifth light-emitting stage V, the third sub-pixel 111c may emit light. In the sixth light-emitting stages VI, the second sub-pixel 111b and the third sub-pixel 111c may emit light. In view of this, the duration of the display period T may be 6t′.

Two or more light-emitting stages of one sub-pixel may or may not be adjacent, which may not affect the implementation of the driving method in the disclosed embodiments. The duration of each light-emitting stage may be substantially equal, and the light-emitting duration of each sub-pixel may be adjusted by adjusting the quantities of light-emitting stages of each sub-pixel. The driving current of each sub-pixel may be substantially equal, the IR-drop may have the same influence on the each sub-pixel, the influence of the IR-drop on the power line on the chromaticity uniformity of the display panel may be improved, and the display performance may be improved.

FIG. 16 illustrates another timing sequence diagram of the display driving method consistent with disclosed embodiments of the present disclosure. Referring to FIG. 16, in the display driving method in the disclosed embodiments, a duration of the display panel displaying one frame image is F, which may include a non-display period N in addition to the display period T. In the non-display period N, the three sub-pixels may not emit light. In one embodiment, referring to FIG. 16, the non-display period N may be followed by the entire light-emitting stages. In another embodiment, the non-display period N may be set between any two light-emitting stages. In certain embodiments, the non-display period N may be set before the entire light-emitting stages. Although the three sub-pixels in the pixel group may not emit light in the non-display period, the non-display period may be used for data written, and signal detection, etc. For example, for a touch display panel, the non-display period may be used for detection of a touch signal.

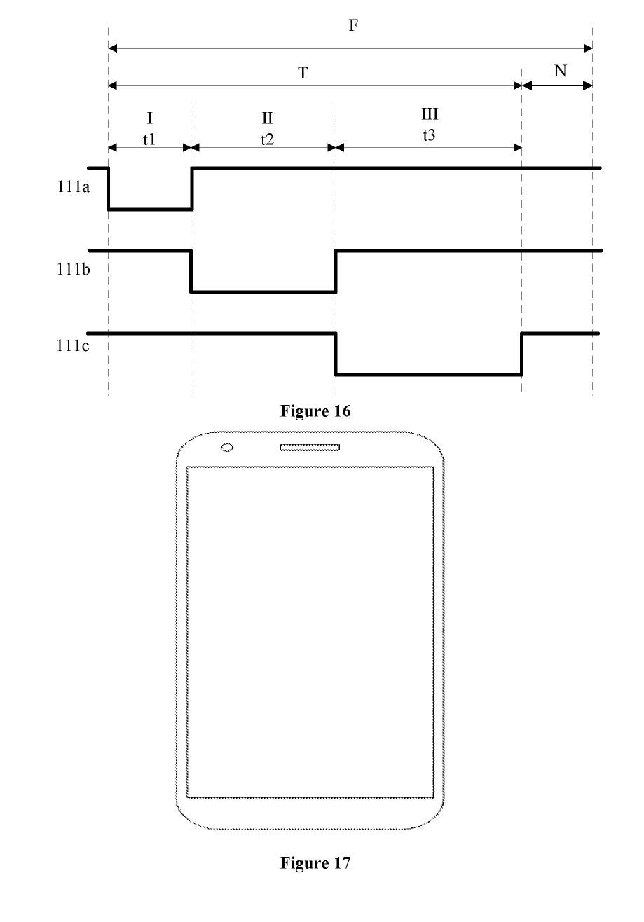

To solve the above technical issues, the present disclosure further provides an organic light-emitting display device. FIG. 17 illustrates a schematic top view of an organic light-emitting display device consistent with disclosed embodiments of the present disclosure. Referring to FIG. 17, the display device may be a mobile phone, a PAD, or a tablet computer, etc., which may be driven by any one of the display driving methods in the disclosed embodiments. The organic light-emitting display device in the disclosed embodiments may be featured with the same advantages as the display driving method in the disclosed embodiments, which are not repeated herein.

In the display driving method and the organic light-emitting display device in the disclosed embodiments, the display color may be adjusted by adjusting the magnitude of the driving current and adjusting the light-emitting duration of the each sub-pixel. Therefore, ensuring the driving current of the each sub-pixel in a same pixel group to be substantially equal, and ensuring the IR-drop on the power line to have the same influence on the driving currents of the sub-pixels of different colors, may improve the chromaticity uniformity of the organic light-emitting display panel and improve the display performance. Moreover, in an organic light-emitting display panel driven by an existing driving method, an organic light-emitting device that emits blue light desires a substantially large driving current, which lowers the lifetime of a blue sub-pixel, and, thus, a lifetime of the blue sub-pixel is often short. In the display driving method in the disclosed embodiments, the driving current of the each sub-pixel may be equal, such that the lifetimes of sub-pixels of different colors may be substantially equal, which may facilitate to improve the service life of the organic light-emitting display panel.

The description of the disclosed embodiments is provided to illustrate the present invention to those skilled in the art. Various modifications to these embodiments will be readily apparent to those skilled in the art, and the generic principles defined herein may be applied to other embodiments without departing from the spirit or scope of the invention. Thus, the present invention is not intended to be limited to the embodiments illustrated herein but is to be accorded the widest scope consistent with the principles and novel features disclosed herein.

What is claimed is:

1. A display driving method for driving an organic light-emitting display panel, wherein:
the organic light-emitting display panel includes a plurality of pixel groups, a pixel group of the plurality of pixel groups includes at least three sub-pixels, and the at least three sub-pixels are used to emit light of three different colors, respectively;
a duration of the organic light-emitting display panel displaying one frame image includes a display period, the display period includes at least two light-emitting stages, and in any one of the light-emitting stages, in any one pixel group of the plurality of pixel groups, at least one sub-pixel emits light; and
the display driving method includes:
in one display period, adjusting a display color of the any one pixel group by adjusting a magnitude of a driving current of each sub-pixel in the any one pixel group and adjusting a light-emitting duration of the each sub-pixel, wherein the driving current of the each sub-pixel is generated by an independent pixel driving circuit, and the driving current of the each sub-pixel in the any one pixel group is substantially equal.

2. The method according to claim 1, wherein:
in the one display period, at least three sub-pixels in the one pixel group emit light, and the three sub-pixels are a first sub-pixel, a second sub-pixel, and a third sub-pixel, respectively, wherein:
a light-emitting duration of the first sub-pixel is a first duration, a light-emitting duration of the second sub-pixel is a second duration, and a light-emitting duration of the third sub-pixel is a third duration,
a ratio of the first duration, the second duration, and the third duration is determined according to the display color of the one pixel group, and
in the one display period, in the any one pixel group, a quantity of sub-pixels that emit light in each light-emitting stage is substantially equal.

3. The method according to claim 2, wherein:
the display period includes three light-emitting stages: a first light-emitting stage, a second light-emitting stage, and a third light-emitting stage, respectively;
in the first light-emitting stage, the first sub-pixel emits light, and a duration of the first light-emitting stage is the first duration;
in the second light-emitting stage, the second sub-pixel emits light, and a duration of the second light-emitting stage is the second duration; and
in the third light-emitting stage, the third sub-pixel emits light, and a duration of the third light-emitting stage is the third duration.

4. The method according to claim 2, wherein:
a sum of the first duration and the second duration is equal to the third duration;
the display period includes two light-emitting stages: a first light-emitting stage, and a second light-emitting stage, respectively;
in the first light-emitting stage, the first sub-pixel and the third sub-pixel emit light, and a duration of the first light-emitting stage is the first duration; and
in the second light-emitting stage, the second sub-pixel and the third sub-pixel emit light, and a duration of the second light-emitting stage is the second duration.

5. The method according to claim 1, wherein:
in the one display period, one or more of a first sub-pixel, a second sub-pixel, and a third sub-pixel emit light;
a light-emitting duration of the first sub-pixel is a first duration, a light-emitting duration of the second sub-pixel is a second duration, and a light-emitting duration of the third sub-pixel is a third duration;
the third duration is equal to 0;
the display period includes two light-emitting stages: a first light-emitting stage, and a second light-emitting stage, respectively;
in the first light-emitting stage, the first sub-pixel emits light, and a duration of the first light-emitting stage is the first duration; and
in the second light-emitting stage, the second sub-pixel emits light, and a duration of the second light-emitting stage is the second duration.

6. The method according to claim 1, wherein:
in the one display period, at least three sub-pixels in the one pixel group emit light, and the three sub-pixels are a first sub-pixel, a second sub-pixel, and a third sub-pixel, respectively, wherein:
a light-emitting duration of the first sub-pixel is a first duration, a light-emitting duration of the second sub-pixel is a second duration, and a light-emitting duration of the third sub-pixel is a third duration,
a ratio of the first duration, the second duration, and the third duration is determined according to the display color of the one pixel group, and
in the one display period, in the any one pixel group, a quantity of sub-pixels that emit light in each light-emitting stage is different.

7. The method according to claim 6, wherein:
the first duration is less than the second duration, and the second duration is less than the third duration;
the display period includes three light-emitting stages: a first light-emitting stage, a second light-emitting stage, and a third light-emitting stage, respectively;
in the first light-emitting stage, the first sub-pixel, the second sub-pixel, and the third sub-pixel emit light, and a duration of the first light-emitting stage is the first duration;
in the second light-emitting stage, the second sub-pixel and the third sub-pixel emit light, and a duration of the second light-emitting stage is a difference between the second duration and the first duration; and
in the third light-emitting stage, the third sub-pixel emits light, and a duration of the third light-emitting stage is a difference between the third duration and the second duration.

8. The method according to claim 6, wherein:
the first duration is equal to the second duration, and the first duration is less than the third duration;
the display period includes two light-emitting stages: a first light-emitting stage, and a second light-emitting stage, respectively;
in the first light-emitting stage, the first sub-pixel, the second sub-pixel, and the third sub-pixel emit light, and a duration of the first light-emitting stage is the first duration; and
in the second light-emitting stage, the third sub-pixel emits light, and a duration of the second light-emitting stage is a difference between the third duration and the first duration.

9. The method according to claim 1, wherein:
in the one display period, one or more of a first sub-pixel, a second sub-pixel, and a third sub-pixel emit light;
a light-emitting duration of the first sub-pixel is a first duration, a light-emitting duration of the second sub-pixel is a second duration, and a light-emitting duration of the third sub-pixel is a third duration;
the third duration is equal to 0, and the first duration is less than the second duration;
the display period includes two light-emitting stages: a first light-emitting stage, and a second light-emitting stage, respectively;
in the first light-emitting stage, the first sub-pixel and the second sub-pixel emit light, and a duration of the first light-emitting stage is the first duration; and
in the second light-emitting stage, the second sub-pixel emits light, and a duration of the second light-emitting stage is a difference between the second duration and the first duration.

10. The method according to claim 1, wherein:
in the one display period, a duration of each light-emitting stage is substantially equal, and a light-emitting duration of each sub-pixel is adjusted by adjusting a quantity of the light-emitting stages, wherein the duration of each light-emitting stage is equal to a greatest common divisor of light-emitting durations of each sub-pixel.

11. The method according to claim 1, wherein:
the duration of the organic light-emitting display panel displaying one frame image further includes a non-display period, wherein:
in the non-display period, the three sub-pixels in the pixel group do not emit light, and
the non-display period is set between any two light-emitting stages, or
the non-display period is set before all the light-emitting stages, or
the non-display period is set after all the light-emitting stages.

12. The method according to claim 1, wherein:
in the one display period, the organic light-emitting display panel is used to display a color other than a pure red screen, a pure blue screen, and a pure green screen.

13. The method according to claim 1, wherein:
the organic light-emitting display panel includes a display region and a non-display region disposed surrounding the display region, wherein a driving chip is disposed in the non-display region, and the driving chip provides a driving voltage for the organic light-emitting display panel to form a driving current; and
sub-pixels of a same color in a same one pixel row are connected to a same one light-emitting signal line, the one light-emitting signal line is electrically connected to the driving chip, and the driving chip respectively provides light-emitting signals for sub-pixels of different colors in the same one pixel row to control whether the each sub-pixel emits light or not.

14. An organic light-emitting display panel driven by a display driving method, comprising:
a plurality of pixel groups, each including at least three sub-pixels used to respectively emit light of three different colors,
wherein:
a duration of the organic light-emitting display panel displaying one frame image includes a display period, the display period includes at least two light-emitting stages, and in any one of the light-emitting stages, in any one pixel group of the plurality of pixel groups, at least one sub-pixel emits light; and
in one display period, a display color of the any one pixel group is adjusted by adjusting a magnitude of a driving current of each sub-pixel in the any one pixel group and adjusting a light-emitting duration of the each sub-pixel, wherein the driving current of the each sub-pixel in the any one pixel group is substantially equal.

15. An organic light-emitting display device comprising the organic light-emitting display panel according to claim 14.
